(19) United States
(12) Patent Application Publication
(10) Pub. No.: US 2024/0409424 A1
(43) Pub. Date: Dec. 12, 2024

(54) Methods for the production of ammonium salts from sour water stripper gas

(71) Applicant: Tessenderlo Group NV, Brussels (BE)

(72) Inventor: Paul Michael Case, Phoenix, AZ (US)

(73) Assignee: Tessenderlo Group NV, Brussels (BE)

(21) Appl. No.: 18/702,346

(22) PCT Filed: Oct. 19, 2022
(86) PCT No.: PCT/EP2022/079022

§ 371 Date: Apr. 18, 2024

(30) Foreign Application Priority Data
Oct. 20, 2021 (EP) 21203667.7

(51) Int. Cl. C01C 1/246

(52) U.S. Cl. CPC C01C 1/246

(57) ABSTRACT

The present invention relates to methods for the production of an ammonium salt wherein sour water stripper gas is reacted with an aqueous medium and wherein the sour water stripper gas (SWSG) is obtained from stripping, preferably steam stripping, of sour water comprising organic compounds, wherein the sour water was submitted to a treatment T1 to reduce the concentration of organic compounds in the sour water before stripping. The present invention also relates to methods for the production of an ammonium salt wherein sour water stripper gas and (concentrated) ammonia are reacted with an aqueous medium such that the ratio (mol:mol) of the total amount of ammonia (NH₃) provided by the sour water stripper gas stream to the total amount of ammonia (NH₃) provided by the concentrated ammonia stream is at least 1:20. The present invention also relates to methods for the production of an ammonium salt wherein sour water stripper gas is reacted with an aqueous medium and wherein the total amount of acyclic C₁-C₉ saturated hydrocarbons comprised in the sour water stripper gas is less than 0.2 mol %.

### FIELD OF THE INVENTION

The present invention relates to methods for the production of ammonium salts from sour water stripper gas and optionally other industrial gases.

### BACKGROUND OF THE INVENTION

Sour water is an ubiquitous wastewater product of e.g. crude oil refineries, where it flows as an effluent from atmospheric and vacuum distillation towers. Sour water is an aqueous composition comprising a major amount of water, ammonia (NH₃), hydrogen sulfide (H₂S), and minor amounts of organic compounds. Sour water must be treated to reduce the ammonia and hydrogen sulfide content before it can be discharged or re-used. This is done by stripping, usually steam stripping, sour water, thereby producing a “sour water stripper gas” or “SWSG”. The SWSG usually contains about ⅓ ammonia (NH₃), about ⅓ hydrogen sulfide (H₂S), and about ⅓ water vapor on a volumetric or molar basis. The SWSG stream also typically contains some carbon dioxide (CO₂) and organic compounds. Other refinery processes produce “acid gas” or “AG”, a refinery off gas rich in H₂S (typically more than 60 mol % H₂S, but can be as high as 99 mol % H₂S) and also containing minor amounts of organic compounds.

Various methods exist to valorize the SWSG by converting it into useful products, such as ammonium salts. Conventionally, SWSG will be fed to a Claus unit, wherein the H₂S comprised in the SWSG is at least partially converted to sulfur, which is burned to SO₂ in an incinerator and which can then be used to produce ammonium salts in absorbers (typically in the form of spray towers or packed columns) according to known processes. For example, U.S. Pat. No. 7,824,652B2 describes the production of ammonium thiosulfate by feeding SWSG to a Claus unit, burning the resulting sulfur in an incinerator and absorbing the resulting SO₂ in a re-circulating ammonium thiosulfate solution.

Because of the high water content of SWSG, it is typically fed to the Claus unit together with acid gas (AG) in order to maintain process efficiency. Most of the ammonia (NH₃) in the SWSG will be converted to nitrogen oxides (NOₓ) or nitrogen gas (N₂), such that a separate ammonia (NH₃) feed is required in order to produce ammonium salts.

A major challenge in the production of ammonium salts from SWSG and AG is the presence of organic compounds. The presence of these compounds presents several processing challenges. For example, although these are largely removed in the incinerator, they take up capacity of the Claus unit and require a lot of air to fully combust.

Another disadvantage of these organic compounds is that in any process wherein SWSG or AG is fed to an absorber, they produce a strong and unpleasant “refinery odor” or “refinery hydrocarbon odor”, reminiscent of odors in refinery processing, in both the gas streams and in products produced from the gas streams, such as in aqueous compositions ammonium salts which are produced from SWSG or AG. The aqueous compositions also typically have a brownish color originating from the contaminants. In general, the end users of the ammonium salts (e.g. farmers in case of ammonium thiosulfate) do not like the odor or color of such aqueous compositions and instead prefer odorless, transparent and colorless fertilizer products. WO2021003479A1 describes methods to eliminate the refinery odor from the aqueous compositions of ammonium salts produced from SWSG and/or AG.

Another disadvantage of these organic compounds is that they cause important fouling of process equipment, in particular the knock-out drums placed before the absorber, and the packing material in the absorbers themselves leading to increased maintenance costs, increased downtime and reduced process efficiency. While U.S. Pat. No. 7,824,652B2 describes the addition of SWSG to the absorber to increase Claus unit capacity, the present inventors have found that in reality the high organic compound content severely limits the amount of SWSG which can be fed to the absorber while maintaining an efficient process.

It is an object of the present invention to provide methods to be able to produce aqueous compositions comprising ammonium salts from SWSG which have increased efficiency or process capacity, increased SWSG ammonia consumption (and thus reduced need for “virgin” ammonia) and/or which may result in products with low refinery organic odor.

### SUMMARY OF THE INVENTION

The present inventors have found that the high organic compound content of SWSG severely limits the amount of SWSG which can be fed to an absorber while maintaining an efficient process because fouling of the equipment will lead to increased maintenance costs, increased downtime and reduced process efficiency, in particular of the demister pads in knock-out drums placed before the absorbers, and the packing material in the absorbers (e.g. in case a packed column is used) themselves. In addition, the hydrocarbons tend to make the control instruments (for example the level transmitter) malfunction and makes it hard to control the level in the absorber. It was surprisingly found that when employing SWSG obtained from stripping sour water which was submitted to a treatment to reduce the concentration of organic compounds in the sour water before stripping, in particular treatment with a liquid-liquid coalescer to separate organic compounds from the aqueous phase, the amount of SWSG which can be fed directly to an absorber (without passing through the Claus unit and incinerator) can be greatly increased. This increases the capacity of the Claus unit and thus overall production capacity, as well as reduced the need for (expensive) ammonia to be fed to the absorber. Another limitation to the amount of SWSG which can be fed directly to an absorber when using traditional SWSG is that as soon as an economically interesting amount of SWSG is fed directly to the absorber, the final ammonium salt product contains so much hydrocarbons that a visible layer separation can even occur in the storage tanks. As will be understood by the skilled person, this finding can be applied to different ammonium salt production processes where SWSG is reacted directly with an aqueous phase (without passing through the Claus unit and incinerator). The use of prior art methods, such as a resin treatment of WO2021003479A1, which takes place after the ammonium salt has been produced, has several disadvantages. For example, it does not prevent fouling of the knock-out drums and absorbers, and the large amount of hydrocarbons carried over to the final product when SWSG is applied directly to the absorber necessitates very frequent and expensive resin replacement.

The inventors have also found that it is often needed or desirable to submit the final product to an additional organic compound removal step, since surprisingly, while organic compound removal at the sour water level is very efficient in preventing equipment fouling, the final product may still suffer from refinery odor caused by ppm or even ppb levels of organic compounds. This is in particular the case if other refinery gases, such as AG or untreated SWSG were also used in the process.

In a first aspect of the present invention there is thus provided a method for the production of an ammonium salt, comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) optionally providing a gaseous process stream B comprising more than 60 mol % (by total of the process stream B) hydrogen sulfide (H₂S);
(iii) optionally providing a process stream C comprising ammonia (NH₃);
(iv) optionally providing a gaseous process stream D comprising sulfur dioxide (SO₂);
(v) reacting process stream A provided in step (i) and optionally one or more of the process streams provided in steps (ii)-(iv) with an aqueous medium to form an aqueous solution of a first ammonium salt;
(vi) optionally submitting the aqueous solution of the first ammonium salt to one or more further reaction steps to form an aqueous solution of a second ammonium salt;
(vii) recovering the aqueous solution of the first ammonium salt of step (v) and/or the aqueous solution of the second ammonium salt of step (vi); and
(viii) optionally submitting one or both of the aqueous solutions recovered in step (vii) to a treatment T2 to reduce the concentration of organic compounds in the aqueous solution;
   wherein
   the process stream A comprises sour water stripper gas (SWSG) obtained from stripping, preferably steam stripping, of sour water comprising organic compounds, wherein the sour water was submitted to a treatment T1 to reduce the concentration of organic compounds in the sour water before stripping; or
   wherein step (iii) is performed and step (v) comprises reacting streams A and C such that the ratio (mol:mol) of the total amount of ammonia (NH₃) provided by stream A to the total amount of ammonia (NH₃) provided by stream C is at least 1:20, preferably at least 1:10, most preferably at least 1:5; or
   wherein the total amount of acyclic C₁-C₉ saturated hydrocarbons comprised in process stream A is less than 0.2 mol % (by total of the process stream A), preferably less than 0.1 mol % (by total of the process stream A), most preferably less than 0.05 mol % (by total of the process stream A).

### BRIEF DESCRIPTION OF THE FIGURES

The present invention will now be described in more detail with reference to specific embodiments of the invention, given only by way of illustration, and with reference to the accompanying drawings.

FIG. 1 is a schematic diagram of the process of embodiment 1.

FIG. 2 is a schematic diagram of the process of embodiment 2.

FIG. 3 is a schematic diagram of the process of embodiment 3.

FIG. 4 is a schematic diagram of the process of embodiment 4.

### DETAILED DESCRIPTION

The expression “comprise” and variations thereof, such as, “comprises” and “comprising” as used herein should be construed in an open, inclusive sense, meaning that the embodiment described includes the recited features, but that it does not exclude the presence of other features, as long as they do not render the embodiment unworkable.

The expressions “one embodiment”, “a particular embodiment”, “an embodiment” etc. as used herein should be construed to mean that a particular feature, structure or characteristic described in connection with the embodiment is included in at least one embodiment. Thus, the appearances of such expressions in various places throughout this specification do not necessarily all refer to the same embodiment. Furthermore, the particular features, structures, or characteristics may be combined in any suitable manner in one or more embodiments. For example, certain features of the disclosure which are described herein in the context of separate embodiments are also explicitly envisaged in combination in a single embodiment.

The singular forms “a,” “an,” and “the” as used herein should be construed to include plural referents unless the content clearly dictates otherwise. It should also be noted that the term “or” is generally employed in its broadest sense, that is as meaning “and/or” unless the content clearly dictates otherwise.

Whenever reference is made throughout this document to a compound which is a salt, this should be construed to include the anhydrous form as well as any solvates (in particular hydrates) of this compound, unless explicitly defined otherwise.

The term “organic compounds” as used herein refers to any compound comprising a carbon-hydrogen bond.

The term “ammonium (bi)sulfite” as used herein should be interpreted to mean “ammonium sulfite ((NH₄)₂SO₃), ammonium bisulfite ((NH₄)HSO₃), or combinations thereof”.

The term “ammonium (bi)sulfide” as used herein should be interpreted to mean “ammonium sulfide ((NH₄)₂S), ammonium bisulfide ((NH₄)₂HS), or combinations thereof”.

The term “ammonium (bi)sulfate” as used herein should be interpreted to mean “ammonium sulfate ((NH₄)₂SO₄), ammonium bisulfate ((NH₄)HSO₄), or combinations thereof”.

As used herein the expression “mol % (by total of process stream A/B/C/D/E/ . . . )” should be interpreted to refer to the mol % calculated based on the total amount (expressed in moles) of all constituents in the mentioned process stream.

The term “Claus unit” as used herein should be interpreted to mean any industrial process unit provided for performing the Claus process. A Claus unit is also interchangeably referred to as “Sulfur Recovery Unit” or “Claus sulfur recovery unit”, and in practice typically comprises multiple sub-units.

The term “Knock-out drum” as used herein should be interpreted to refer to any (sudden) diameter increase installed in a pipeline for purifying gas streams by removing liquids or liquid droplets from a gas stream. Knock-out drums are known to the skilled person and are large drums placed in between pipeline sections which have a diameter large enough to reduce vapour velocity low enough to allow entrained liquids to settle or drop out. The knock-out drums typically comprise a mesh or grid (plastic or stainless steel), also referred to as a “demister pad” to encourage liquid settling/drop-out.

The term “sour water” as used herein refers to an aqueous composition comprising a major amount of water (more than 50 wt. % by total weight of the sour water), ammonia (NH₃), hydrogen sulfide (H₂S), and organic compounds (typically in minor amounts of <5 wt. % by total weight of the sour water). Notable other impurities typically present in sour water are CO₂ (typically 0-2 wt. %) and inorganic cyanides (<100 ppm).

In accordance with the invention, suitable ammonium salts which can be made with the method described herein are ammonium thiosulfate, ammonium (bi)sulfide, ammonium polysulfide and ammonium (bi)sulfate. Whenever ammonium (bi)sulfate is mentioned throughout this document, ammonium sulfate is preferred. Hence, in preferred embodiments of the invention, the method is for the production of an ammonium salt selected from the group consisting of ammonium thiosulfate, ammonium (bi)sulfide, ammonium polysulfide, ammonium (bi)sulfate and combinations thereof.

Although inclusion of one or more additives or mixing of the SWSG with other streams to obtain the process stream A is not excluded, it will be understood by the skilled person, in light of the present description, that typically the process stream A will consist essentially of the SWSG obtained from stripping, preferably steam stripping, of sour water comprising organic compounds, wherein the sour water was submitted to a treatment T1 to reduce the concentration of organic compounds in the sour water before stripping.

The present inventors envisage that the sour water stripping and preceding treatment T1 will typically be performed by a different company, such as a refinery, than the company processing the SWSG, such that the present method simply employs the SWSG obtained from sour water which was submitted to a treatment T1. However, in accordance with preferred embodiments, step (i) of the method explicitly comprises the following steps:
(i)a providing sour water comprising organic compounds;
(i)b submitting the sour water to a treatment T1 to reduce the concentration of organic compounds in the sour water, thereby obtaining sour water with a reduced concentration of organic compounds; and
(i)c submitting the sour water obtained in step (i)b to stripping, preferably steam stripping, to obtain the sour water stripper gas (SWSG) comprised in process stream A.

The treatment T1 may be performed with any technique suitable to reduce the concentration of organic compounds in the sour water, such as sand bed filtration, API oil-water separator treatment, electrostatic precipitation, membrane filtration, liquid-liquid coalescing, etc.

In highly preferred embodiments of the invention, the treatment T1 comprises treatment with a liquid-liquid coalescer. The present inventors have found that this is a highly effective method to separate organic compounds from the sour water, thereby obtaining sour water with a reduced concentration of organic compounds. Liquid-liquid coalescers are known to the skilled person, see e.g. Perry's Chemical Engineering Handbook 6th Ed. Pages 21-65 to 21-66. The invention is not particularly limited to the exact type of liquid-liquid coalescer, such as plate coalescers, cartridge coalescers, repack coalescers, etc. The coalescer may be provided as a vertical or horizontal coalescer. An example of a commercially available liquid-liquid coalescer is the “Pall AquaSep® Series Liquid/Liquid Coalescer” or the “Pentair HRT™ series”. The coalescer typically employs a cartridge or packing material made from glass fibers, polypropylene fibers, or polyester fibers, although other materials can also be used.

In preferred embodiments of the invention, in particular when the treatment T1 comprises treatment with a liquid-liquid coalescer, the sour water was submitted to a regular particulate filtration step before the treatment T1. The regular particulate filtration step before the treatment T1 is preferably performed with a filter having a pore size within the range of 5-50 micron, preferably 5-20 micron, most preferably about 10 micron.

To have a reasonable reduction in hydrocarbon content and thus achieve the aforementioned benefits of the present invention, typically treatment T1 is performed such that the ratio TOC₀:TOC_{A} is more than 1.1:1, preferably more than 1.2:1, more preferably more than 1.4:1, wherein TOC₀ is the total organic carbon content (TOC) of the sour water before the treatment T1, and wherein TOC_{A} is the total organic carbon content (TOC) of the sour water after the treatment T1. It is preferred that treatment T1 is performed such that the ratio TOC₀:TOC_{A} is more than 2:1, preferably more than 5:1, more preferably more than 10:1, wherein TOC₀ is the total organic carbon content (TOC) of the sour water before the treatment T1, and wherein TOC_{A} is the total organic carbon content (TOC) of the sour water after the treatment T1. The inventors have found that using a liquid-liquid coalescing skid, an efficiency of more than 90% hydrocarbon removal, such as more than 95%, or even 98% can be achieved. Hence, employing a liquid-liquid coalescer the preferred TOC₀:TOC_{A} ratios recited previously can easily be achieved.

The organic compounds present in sour water are typically a complex mixture of compounds such as monocyclic aromatics (for example, one or more of alkyl benzenes, alkenyl benzenes, alkynyl benzenes, aryl benzenes, aryl halides, phenols, thiophenols, anilines, aryl carboxylic acids, aryl carboxylic acid esters, aryl carboxylic acid amides, aryl sulfones, aryl sulfonates, and aryl phosphonates), and polycyclic aromatics, including bicyclic aromatics (for example, one or more of tetrahydronaphthalene, substituted tetrahydronaphthalenes, indane, and substituted 1H-indenes), fused polyaromatics (for example, one or more of naphthalene and substituted naphthalenes), and non-fused polyaromatics, and heteroaromatic variations of such compounds having one or more hetero atoms in the aromatic ring(s), including mono-heteroaromatics (for example, one or more of pyridine, substituted pyridine, thiophene, substituted thiophene, furan, substituted furans, pyrrole, substituted pyrroles, pyridazines, pyrimidines, pyrazines, imidazoles, oxazoles, isooxazoles, thiazoles, isothiazoles and pyrazoles), bicyclic heteroaromatics (for example, one or more of tetrahydroquinolines, tetrahydroisoquinolines, tetrahydrocinnolines, tetrahydroquinazolines and tetrahydroquinoxalines), bicyclic polyheteroaromatics (for example, one or more of quinolines, isoquinolines, cinnolines, quinazolines and quinoxalines, indoles, benzofurans, benzothiofurans, indazoles, benzoimidazoles, benzooxazoles, benzoisooxazoles, benzothiaazoles, and benzoisothiazoles), as well as alicyclic compounds with no, one or multiple heteroatoms in the ring(s) (for example, one or more of cyclopentanes, tetrahydrofurans, tehrahydrothiophenes, pyrolidines, morpholines, piperazine, and hiamorpholines). Heteroatoms include O, N and S. The compounds may be substituted with one or more groups, examples of which include, but are not limited to, halo, alkyl, aryl, nitro, benzoyl, nitroso, thio and/or aldehyde groups. The exact composition of these odor-causing refinery hydrocarbon contaminants in such gas streams can change from time to time depending on the crude material which was processed to produce the gas stream. In accordance with preferred embodiments of the invention, the treatment T1 is performed such that the concentration of at least one, preferably at least 10 of the aforementioned organic compounds is decreased by at least 50%, preferably by at least 80%. More preferably the treatment T1 is performed such that the concentration of at least one, preferably all of pyridine, phenol, analine, benzene, toluene, xylene, C₆-C₁₀ hydrocarbons, C₁₁-C₂₈ hydrocarbons is decreased by at least 50%, preferably by at least 80%; or such that the combined concentration of pyridine, phenol, analine, benzene, toluene, xylene, C₆-C₁₀ hydrocarbons, C₁₁-C₂₈ hydrocarbons is decreased by at least 50%, preferably by at least 80%. A suitable method to determine the % decrease is by performing GC/MS analysis on a dichloromethane extract of the sour water before treatment T1 and on a dichloromethane extract of the sour water after treatment T1 and comparing the peak area of at least one, preferably of at least 10 of the aforementioned organic compounds. A preferred extraction and GC/MS method is the following method: placing 100 ml of a liquid sample (in a 250 ml separation funnel, adding 20 ml of redistilled dichloromethane, shaking vigorously for 5 minutes and collecting the dichloromethane phase, repeating the extraction three times to obtain a total of about 60 ml dichloromethane phase which is frozen overnight and then filtered using Whatman 1PS phase separator filter paper to remove residual water, adding one gram of anhydrous sodium sulfate, evaporating the dichloromethane at room temperature to obtain a 0.5 ml concentrate for GC analysis employing an Agilent 6890 gas chromatograph equipped with an Agilent 5973 mass spectrometer and a ZB-WAX column (30 m×0.25 mm i.d., 0.5 μm film thickness, Phenomenex Inc., Torrance, CA) operated at a column flow rate of 2 mL/min, employing an initial oven temperature of 80° C. which is held for 2 min, then increased to 180° C. at a rate of 2° C./min, and then ramped to 230° C. at a rate of 6° C./min with a 6 min hold at the final temperature, using Injection port, MS transfer line, and ion source temperatures of 250° C., 280° C., and 230° C. respectively and collecting electron ionization mass spectrometric data from m/z 40 to 250.

Since sour water contains only minor amounts of organic compounds (typically less than 5 wt. % (by total weight of the sour water)), the overall composition of the sour water is not fundamentally changed from the composition of the sour water before treatment T1. In preferred embodiments of the invention, the sour water before and after the treatment T1 comprises
at least 90 wt. % (by total weight of the sour water) water, preferably at least 95 wt. % water;
at least 0.05 wt. % (by total weight of the sour water) ammonia (NH₃), preferably at least 0.1 wt. % ammonia (NH₃); and
at least 0.05 wt. % (by total weight of the sour water) hydrogen sulfide (H₂S), preferably at least 0.1 wt. %) hydrogen sulfide (H₂S).
The sour water typically has a pH before and/or after treatment T1 within the range of 7.5-9.5.
The sour water typically contains less than 5 wt. % (by total weight of the sour water), such as less than 2 wt. % of each of ammonia (NH₃) and hydrogen sulfide (H₂S).

Since process stream A comprises SWSG obtained from sour water which contains organic compounds before stripping, in nearly every practical application this implies that the process stream A originates from a petroleum refinery process. Hence in preferred embodiments of the invention process stream A originates from a petroleum refinery process.

In accordance with typical concentrations of SWSG, it is preferred that the process stream A comprises more than 25 mol % (by total of the process stream A) of hydrogen sulfide (H₂S), more than mol % (by total of the process stream A) of ammonia (NH₃) and more than 25 mol % (by total of the process stream A) of water vapor (H₂O), more preferably wherein the process stream A comprises more than 30 mol % (by total of the process stream A) of hydrogen sulfide (H₂S), more than 30 mol % (by total of the process stream A) of ammonia (NH₃) and more than 25 mol % (by total of the process stream A) of water vapor (H₂O).

Process stream B may comprise H₂S from any source, however in nearly every practical application process stream B is acid gas (AG) which originates from a petroleum refinery process. Hence in preferred embodiments of the invention process stream B originates from a petroleum refinery process.

In accordance with typical concentrations of acid gas, it is preferred that process stream B comprises more than 80 mol % (by total of the process stream B) hydrogen sulfide (H₂S). In some embodiments, where highly concentrated AG is available, process stream B may even comprise more than 90 mol % (by total of the process stream B) hydrogen sulfide (H₂S), preferably more than 95 mol % (by total of the process stream B) hydrogen sulfide.

Process stream C typically comprises more than 60 mol % (by total of the process stream C) Process stream C may comprise anhydrous or aqueous ammonia (NH₃). However, the use of anhydrous ammonia is preferred as the SWSG of process stream A already brings a lot of water into the process. Process stream may be provided as a liquid or gas, however it is preferred to provide process stream C in the form of liquified anhydrous ammonia (typically under a pressure of 10-15 bar). As will be understood by the skilled person, the ammonia will vaporise when introduced into the absorber.

Process stream D may originate from any suitable SO₂ source. It is typically obtained by burning off-gases from a Claus unit but may also be obtained from a sulfur burning installation or by burning SWSG or AG without passing through a Claus unit. In accordance with highly preferred embodiments of the invention, step (iv) is performed and step (iv) comprises the following steps:
(iv)a providing a process stream E comprising more than 60 mol % (by total of the process stream E) hydrogen sulfide (H₂S);
(iv)b optionally reacting the process stream E in a Claus unit, wherein the H₂S comprised in the process stream E is at least partially converted to sulfur, thereby obtaining a process stream E′ comprising the off-gases of the Claus unit, the process stream E′ having a lower H₂S content than the process stream E; and
(iv)c incinerating the process stream E and/or the process stream E′ in an incinerator, wherein the H₂S comprised in process stream E and/or process stream E′ is at least partially converted to SO₂, thereby obtaining the process stream D.

The incinerator, if operated properly, will typically and preferably convert all H₂S in the gas streams to SO₂.

Step (iv)c of the process may further comprise the addition of sulfur to the incinerator. In view of the economic value of sulfur, this is typically only done in case the H₂S content of process stream E or E′ is too low to provide the desired amount of SO₂ and/or in case the available volume of process stream E or E′ is too low to provide the desired amount of SO₂.

The oxygen supply to the incinerator of step (iv)c is typically provided in the form of air using air blowers, but may also be provided in the form of oxygen-enriched air, or even pure (e.g. more than 90 mol %) oxygen. As will be understood by the skilled person, this influences the SO₂ concentration in process stream D, as air mostly contains inerts (nitrogen gas). The concentration of SO₂ in process stream D is not particularly limiting, but will typically be at least 3 mol % (by total of the process stream D) SO₂, such as within the range of 4-20 mol % (by total of the process stream D) SO₂ for installations using air blowers to feed the incinerator. However, higher concentrations such as more than 20 mol % (by total of the process stream D) SO₂ are achievable when oxygen-enriched air or pure oxygen is used to feed the incinerator.

As will be understood by the skilled person based on the present disclosure, process stream E typically corresponds with AG. Hence, (similar to the preferred embodiments set out earlier for process stream B), process stream E may comprise H₂S from any source, however in nearly every practical application process stream E is acid gas (AG) which originates from a petroleum refinery process. Hence in preferred embodiments of the invention process stream E originates from a petroleum refinery process. In accordance with typical concentrations of acid gas, it is preferred that process stream E comprises more than 80 mol % (by total of the process stream E) hydrogen sulfide (H₂S). In some embodiments, where highly concentrated AG is available, process stream E may even comprise more than 90 mol % (by total of the process stream E) hydrogen sulfide (H₂S), preferably more than 95 mol % (by total of the process stream E) hydrogen sulfide.

It is preferred that the process stream B and the process stream E originate from the same feed stream which is split into a portion forming the process stream B and into a portion forming the process stream E. In accordance with the preferred embodiments of the invention described above, the feed stream which is split into process stream B and process stream E is acid gas originating from a petroleum refinery process.

In accordance with preferred embodiments of the invention, step (iv)b is performed. Such a process preferably further comprises providing a process stream F comprising more than 20 mol % (by total of the process stream F) of hydrogen sulfide (H₂S), more than 20 mol % (by total of the process stream F) of ammonia (NH₃) and more than 20 mol % (by total of the process stream F) of water vapor (H₂O), and reacting the process stream F in the Claus unit of step (iv)b together with the process stream E. Process stream F comprises SWSG. Although inclusion of one or more additives or mixing of SWSG with other streams to obtain the process stream F is not excluded, it will be understood by the skilled person, in light of the present description, that typically the process stream F will consist essentially of SWSG. Hence, (similar to the preferred embodiments set out earlier for process stream A), in preferred embodiments of the invention process stream F originates from a petroleum refinery process. In accordance with typical concentrations of SWSG, it is preferred that the process stream F comprises more than 25 mol % (by total of the process stream F) of hydrogen sulfide (H₂S), more than 25 mol % (by total of the process stream F) of ammonia (NH₃) and more than 25 mol % (by total of the process stream F) of water vapor (H₂O), more preferably wherein process stream F comprises more than 30 mol % (by total of the process stream F) of hydrogen sulfide (H₂S), more than 30 mol % (by total of the process stream F) of ammonia (NH₃) and more than 25 mol % (by total of the process stream F) of water vapor (H₂O).

In some embodiments of the invention, the process stream A and the process stream F originate from the same feed stream comprising sour water stripper gas (SWSG) which is split into a portion forming the process stream A and into a portion forming the process stream F. As the SWSG of process stream A was obtained from stripping sour water which was submitted to a treatment T1 as described herein elsewhere, in this embodiment where the process stream A and the process stream F originate from the same feed stream this means that the process stream F is inevitably also a low hydrocarbon SWSG. This may have certain advantages, such as a reduced oxygen consumption in the incinerator of step (iv)c (as hydrocarbon burning consumes more oxygen than H₂S or NH₃ burning).

In alternative embodiments of the invention, the process stream A and the process stream F originate from different feed streams comprising sour water stripper gas (SWSG) having different total organic carbon (TOC) contents. It is clear that if two gas streams have a different organic compounds content, they will inevitably have different total organic carbon (TOC) contents. This is the case if, in accordance with some embodiments of the invention, process stream A was obtained from stripping sour water which was submitted to a treatment T1 as described herein elsewhere, while process stream F was not submitted to such a treatment T1 but is used as such, or was submitted to a different, less effective hydrocarbon removal treatment. This embodiment may have certain advantages, such as a reduced cost of operating the treatment T1 since not all SWSG employed in the process of the invention needs to be generated from sour water which was submitted to treatment T1. Hence, in this embodiment it is preferred that the process stream F comprises sour water stripper gas (SWSG) obtained from stripping, preferably steam stripping, of sour water having a total organic carbon (TOC) content TOC_{F}, and the process stream A comprises sour water stripper gas (SWSG) obtained from stripping, preferably steam stripping, of sour water having a total organic carbon (TOC) content TOC_{A}, and wherein the ratio TOC_{F}:TOC_{A} is more than 5:1, preferably more than 10:1, more preferably more than 20:1.

As explained herein earlier, one of the advantages of the methods of the present invention is that the amount of SWSG which can be fed directly to an absorber (without passing through the Claus unit and incinerator) can be greatly increased, resulting in a reduced need for (expensive) ammonia to be fed to the absorber. Hence, in accordance with preferred embodiments of the invention, step (iii) is performed and step (v) comprises reacting streams A and C such that the ratio (mol:mol) of the total amount of ammonia (NH₃) provided by stream A to the total amount of ammonia (NH₃) provided by stream C is at least 1:20, preferably at least 1:10, most preferably at least 1:5. In case enough SWSG supply is available, the ratio (mol:mol) of the total amount of ammonia (NH₃) provided by stream A to the total amount of ammonia (NH₃) provided by stream C can be at least 1:3 or even more. In preferred embodiments of the invention, step (v) is implemented as a continuous process, step (iii) is performed and step (v) comprises reacting streams A and C such that the ratio (mol:mol) of the total amount of ammonia (NH₃) provided by stream A per hour to the total amount of ammonia (NH₃) provided by stream C per hour is at least 1:20, preferably at least 1:10, most preferably at least 1:5. In case enough SWSG supply is available, the ratio (mol:mol) of the total amount of ammonia (NH₃) provided by stream A per hour to the total amount of ammonia (NH₃) provided by stream C per hour can be at least 1:3 or even more.

The inventors have also found that it is often needed or desirable to submit the final product to an additional organic compound removal step, since surprisingly, while organic compound removal at the sour water level is very efficient in preventing equipment fouling, the final product may still suffer from refinery odor caused by ppm or even ppb levels of organic compounds. This is in particular the case if other refinery gases, such as AG or untreated SWSG were also used in the process. Hence, in accordance with preferred embodiments of the invention, step (viii) is performed. The treatment T2 may comprise treatment by known odor removal methods such as activated carbon treatment, stripping with air or nitrogen gas, or more advanced resin purification treatments such as those described in WO2021003479A1, incorporated herein by reference. It is noted that stripping with air or another oxidizing agent is not suitable in case the ammonium salt is ammonium thiosulfate, as it will cause over-oxidation of the thiosulfate to sulfate. Hence, in some embodiments of the invention, step (viii) is applied with the provisio that the treatment T2 is not stripping with air or another oxidizing agent if the aqueous solution being treated is an ammonium thiosulfate solution. The treatment T2 may also comprise or consist of treatment with a liquid/liquid coalescer. The specifics of such liquid/liquid coalescers are described herein elsewhere for treatment T1 and are equally applicable to treatment T2.

In particularly preferred embodiments, the treatment T2 comprises contacting the aqueous solution of the ammonium salt with a sorbent material, wherein the sorbent material comprises
(a) a macroporous hydrophobic nonfunctionalized resin having a BET surface area ranging from about 500 to about 1500 m²/g and a total porosity of greater than about 0.9 ml/g; and/or
(b) granular activated carbon and optionally glass fibers having a diameter ranging from about 0.001 to about 0.1 mm.

A “sorbent” material is a material that adsorbs or absorbs a certain substance or certain substances from a liquid or a gas. In this case, the sorbent adsorbs or absorbs organic molecules such as hydrocarbons and derivatives thereof carried over from the gas streams employed in the process of the invention. Adsorbents act by surface sorption while absorbents act by bulk sorption. When effecting treatment T2 using the preferred sorbent materials as described herein, an aqueous composition of ammonium salt is obtained which, despite containing contaminating refinery hydrocarbons detectable by GC/MS, nonetheless contain the refinery hydrocarbons in an amount below the olfactive detection limit whereby the aqueous compositions of the invention are free of refinery odor. In accordance with the invention, the sorbent material is stable in organic solvents, and/or strong bases (pKa>12, for example, 4-10% solutions of sodium hydroxide or potassium hydroxide) and/or strong acids (for example, 4-10% solutions of sulfuric acid or hydrochloric acid). In one embodiment, the sorbent material is in the form of a particulate solid, preferably spherical particles such as granules or beads. In a more preferred embodiment, the sorbent material is in the form of spherical particles with a crush strength greater than about 300 g/particle, preferably greater than about 400 g/particle. Crush strength is determined by taking a representative sample of at least about 20 particles from a given sample of sorbent particles, and determining the force, in grams, needed to fracture each bead using a Chatillon Scale, Model DPP-IKG, available from J. Chatillon & Sons Company. Crush strength is reported as the average of the force measurements obtained for the 20 beads.

The macroporous hydrophobic resin sorbent is nonfunctionalized, i.e., it does not have ion exchange properties. The combination of macroporosity and total porosity of greater than about 0.9 mL/g, providing a BET surface area ranging from about 500 to about 1,500 m²/g in the resin is advantageous for removing the refinery odor-causing contaminating hydrocarbons. The BET surface area is measured according to the well-known BET nitrogen adsorption technique (see, for example, Sing, Colloids and Surfaces A: Physicochem. Eng. Aspects, 187-188:3-9 (2001)). The term “macroporous” refers in general to porous polymers having regions of densely packed polymer chains separated by cellular void spaces that constitute the macropores. The macropores generally have diameters of about 100 Å or greater, for example, in a range of about 100 to about 2000 Å. Of the total porosity, the amount contributed by macropores is, for example, from about 0.02 to about 0.6 cc/g, more specifically, from about 0.03 to about 0.5 cc/g. Suitable resins include, but are not limited to, those having a hydrophobic surface and containing aromatic groups. The resin sorbent attracts organic material and has a strong affinity for molecules with aromatic groups and/or alkyl chains. In a specific embodiment, the resin comprises a crosslinked vinyl resin, for example, a monovinylidine aromatic monomer, crosslinked with vinylaromatic such as divinylbenzene or trivinylbenzene, or acrylate vinylidene resins. More specific examples include, but are not limited to, crosslinked polystyrene resins or crosslinked substituted polystyrene resins (alkylstyrenes, halostyrenes, haloalkylstyrenes), and/or crosslinked acrylic or methacrylic resins, and the like. Such resins are commercially available.

In embodiments where the sorbent material comprises granular activated carbon and glass fibers, the aqueous stream may be first contacted with the activated carbon, followed by contact with the glass fibers, or alternatively, the aqueous stream may be first contacted with the glass fibers, followed by contact with the activated carbon, or the aqueous stream may be contacted with the activated carbon and glass fibers simultaneously, i.e. in a bed packed with both activated carbon and glass fibers.

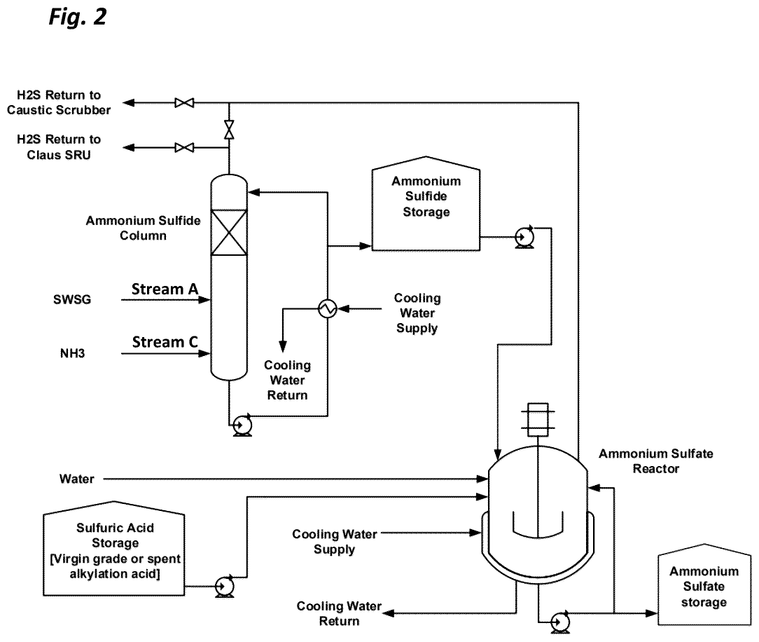

The method of the invention may be operated in batch or continuous form It is preferably operated such that at least step (v) is implemented as a continuous process, as this is the most practical way to implement a process employing absorbers such as columns or spray towers. The optional step (vi) may still be implemented in a discontinuous manner, which is possible when a storage tank is present downstream of the absorber(s) used in step (v), as is illustrated in e.g. FIG. 2.

The reaction step (v) can be performed in any suitable gas-liquid reactor (also interchangeably referred to herein as an “absorber”), which is typically equipment that permits rapid, intimate contact of the gaseous process stream(s) and the aqueous medium, for example, a falling-film column, a packed column, a bubble column, a spray-tower, a gas-liquid agitated vessel, a plate column, a rotating disc contactor, a venturi tube, etc. The functioning of such absorbers is known to the skilled person, and in the case of vertical absorbers (e.g. columns, spray-towers) typically involves introducing one or more gas streams at the bottom part of the absorber, and introducing an aqueous phase at the top part of the absorber, such that the gas and the aqueous phase react in counter-current. The aqueous phase accumulates in the bottom part, where a level meter monitors the liquid level and activates a pump to safeguard a maximum liquid level. As explained herein earlier, the present inventors have found that using regular SWSG inter alia leads to considerable fouling of the level meter, disturbing its functioning.

In accordance with highly preferred embodiments of the invention, reaction step (v) comprises reaction in a packed column absorber and/or a spray-tower absorber. The packing material can be any packing material, such as random packing (e.g. Raschig rings or saddles) of any material (e.g. polymeric or stainless steel). Preferably the absorber is equipped with a liquid level meter, which preferably is provided to safeguard a maximum liquid level by activating a pump. Preferably one or more knock-out drums is present before the absorber.

While typically not necessary, reaction step (v) may be performed as a multi-step absorption process wherein two or more consecutive absorbers are used to maximize the amount of ammonia and/or hydrogen sulfide absorbed from the process stream 1, and/or to increase the concentration of the first ammonium salt.

In some embodiments, the first ammonium salt is simply the ammonium salt being produced with the method of the invention and step (vi) is not performed. As will be understood by the skilled person, this embodiment corresponds to a reaction scheme wherein the process stream A (i.e. the SWSG obtained from stripping sour water which was submitted to a treatment T1 as described herein elsewhere) is fed to the absorber where the desired thiosulfate is formed. For example, as will be explained in more detail in Embodiment 1, in case the method is for producing ammonium thiosulfate, reaction step (v) involves reacting the process stream A with an ammonium (bi)sulfite solution to produce ammonium thiosulfate, and no step (vi) is required.

In alternative embodiments, the first ammonium salt is an intermediate ammonium salt and step (vi) is performed in order to transform the intermediate ammonium salt to the desired ammonium salt. As will be understood by the skilled person, this embodiment corresponds to a reaction scheme wherein an intermediate ammonium salt (the first ammonium salt) is prepared by reacting process stream A (i.e. the SWSG obtained from stripping sour water which was submitted to a treatment T1 as described herein elsewhere) in an absorber to obtain an intermediate ammonium salt, followed by conversion of the intermediate ammonium salt to the desired ammonium salt. For example, as will be explained in more detail in Embodiment 2, in case the method is for producing ammonium (bi)sulfate, reaction step (v) involves reacting the process stream A with an aqueous medium to obtain ammonium (bi)sulfide (the first ammonium salt), which is subsequently reacted in step (vi) to ammonium (bi)sulfate by reaction with sulfuric acid.

In case step (vi) is performed, it may comprise further reaction of the aqueous solution of the first ammonium salt obtained in step (v) with one or more of the process streams provided in steps (i)-(iv), and/or reaction of the aqueous solution of the first ammonium salt obtained in step (v) with other reagents than the process streams provided in steps (i)-(iv), such as sulfuric acid in case ammonium (bi)sulfate is being prepared.

Particular reaction schemes will now be explained in more detail in the form of specific embodiments 1-4 of the present invention. The preferred embodiments of the invention described above are applicable to each of embodiments 1-4, unless embodiments 1-4 explicitly define otherwise.

### Embodiment 1: Production of Ammonium Thiosulfate

In a particularly preferred embodiment of the invention, referred to herein as “embodiment 1”, there is provided a method for the production of ammonium thiosulfate wherein step (v) involves reacting process stream A with an aqueous medium comprising ammonium (bi)sulfite. Embodiment 1 is preferably a method for the production of ammonium thiosulfate comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) providing a gaseous process stream B comprising more than 60 mol % (by total of the process stream B) hydrogen sulfide (H₂S);
(iii) providing a process stream C comprising ammonia (NH₃);
(iv) providing a gaseous process stream D comprising more than 10 mol % (by total of the process stream D) sulfur dioxide (SO₂);
(v) reacting process streams A, B and C provided in steps (i)-(iii) with an aqueous medium comprising ammonium (bi)sulfite to form an aqueous solution of ammonium thiosulfate;
(vii) recovering the aqueous solution of ammonium thiosulfate of step (v); and
(viii) optionally submitting the aqueous solution recovered in step (vii) to a treatment T2 to reduce the concentration of organic compounds in the aqueous solution;
   wherein step (iv) comprises the following steps:
(iv)a providing a process stream E comprising more than 60 mol % (by total of the process stream E) hydrogen sulfide (H₂S);
(iv)b reacting the process stream E in a Claus unit, wherein the H₂S comprised in the process stream E is at least partially converted to sulfur, thereby obtaining a process stream E′ comprising the off-gases of the Claus unit, the process stream E′ having a lower H₂S content than the process stream E; and
(iv)c incinerating the process stream E and/or the process stream E′, preferably incinerating the process stream E′ in an incinerator, wherein the H₂S comprised in process stream E and/or process stream E′ is at least partially converted to SO₂, thereby obtaining the process stream D;
   wherein the aqueous medium comprising ammonium (bi)sulfite is obtained from reacting process stream D and ammonia (NH₃) with an aqueous medium; and
   wherein the process stream A comprises sour water stripper gas (SWSG) obtained from stripping, preferably steam stripping, of sour water comprising organic compounds, wherein the sour water was submitted to a treatment T1 to reduce the concentration of organic compounds in the sour water before stripping.

In embodiment 1, step (vi) is not performed since the SWSG is used to make the end product (ammonium thiosulfate), and not to make an intermediate (as is the case in e.g. embodiment 2 and embodiment 4).

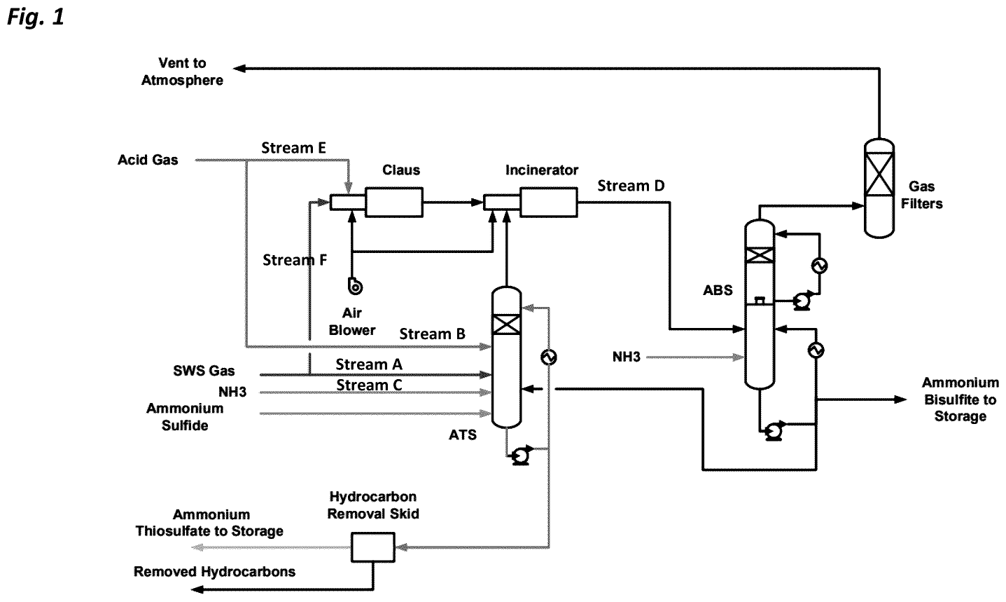

A specific implementation of embodiment 1 is illustrated in FIG. 1.

As can be seen in the process scheme of FIG. 1, in this implementation of embodiment 1, the process stream B and the process stream E originate from the same feed stream of acid gas (preferably originating from a petroleum refinery process) which is split into a portion forming the process stream B and into a portion forming the process stream E.

Furthermore, as can be seen in the process scheme of FIG. 1, the process further comprises providing a process stream F comprising more than 20 mol % (by total of the process stream F) of hydrogen sulfide (H₂S), more than 20 mol % (by total of the process stream F) of ammonia (NH₃) and more than 20 mol % (by total of the process stream F) of water vapor (H₂O), and reacting the process stream F in the Claus unit of step (iv)b together with the process stream E, and the process stream A and the process stream F originate from the same feed stream of SWSG which was submitted to a treatment T1 as described herein elsewhere.

The optional step (viii) is also illustrated in the process scheme of FIG. 1.

As is also shown in FIG. 1, the process of embodiment 1 preferably further comprises a feed of ammonium sulfide to the absorber of step (v).

In accordance with preferred implementations of embodiment 1, reaction step (v) is performed by continuously reacting process stream A, B and C provided in steps (i)-(iii) with a continuously recirculating aqueous medium comprising ammonium (bi)sulfite and ammonium thiosulfate, wherein step (vii) comprises obtaining a continuous bleed stream from the continuously recirculating aqueous medium. In practice, the flow rate (e.g. in liter/hour) of liquid recirculated is typically at least 50, preferably at least 100 times the flow rate of the bleed stream, such that the ammonium thiosulfate gradient in the absorber is kept relatively small and the absorber can continuously operate under optimal conditions. The continuously recirculating aqueous medium preferably comprises 50-60 wt. % ammonium thiosulfate, 1-4 wt. % ammonium sulfite, 35-45 wt. % water and less than 5 wt. % ammonium sulfate. Reaction step (v) is preferably performed at a temperature within the range of 40-80° C.

In accordance with preferred implementations of embodiment 1, the aqueous medium comprising ammonium (bi)sulfite is obtained from reacting process stream D and ammonia (NH₃) with an aqueous medium at a temperature within the range of 30-70° C.

### Embodiment 2: Production of Ammonium (Bi) Sulfate

In a particularly preferred embodiment of the invention, referred to herein as “embodiment 2”, there is provided a method for the production of ammonium (bi)sulfate (preferably ammonium sulfate) wherein step (v) comprises reacting process stream A with an aqueous medium to form an aqueous solution of ammonium (bi)sulfide and step (vi) comprises reacting the ammonium (bi)sulfide obtained in step (v) with sulfuric acid to obtain ammonium (bi)sulfate (preferably ammonium sulfate). Embodiment 2 is preferably a method for the production of ammonium (bi)sulfate (preferably ammonium sulfate), comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) optionally providing a gaseous process stream B comprising more than 60 mol % (by total of the process stream B) hydrogen sulfide (H₂S);
(iii) optionally providing a process stream C comprising ammonia (NH₃);
(v) reacting process stream A provided in step (i), and optionally process streams B and C provided in step (ii) and (iii) with an aqueous medium to form an aqueous solution of ammonium (bi)sulfide;
(vi) submitting the aqueous solution of ammonium (bi)sulfide to one or more further reaction steps to form an aqueous solution of ammonium (bi)sulfate;
(vii) recovering the aqueous solution of ammonium (bi)sulfate of step (vi); and
(viii) optionally submitting the aqueous solution recovered in step (vii) to a treatment T2 to reduce the concentration of organic compounds in the aqueous solution;
   wherein
   the process stream A comprises sour water stripper gas (SWSG) obtained from stripping, preferably steam stripping, of sour water comprising organic compounds, wherein the sour water was submitted to a treatment T1 to reduce the concentration of organic compounds in the sour water before stripping.

In embodiment 2, step (iv) is generally not required since the process does not require SO₂.

Step (ii) is optional and can be performed in case the SWSG has a low H₂S content or in case a more concentrated product or higher production capacity is desired.

Step (iii) is optional if ammonium bisulfide is being produced in step (v) and can be performed in case the SWSG has low ammonia content or in case a more concentrated product or higher production capacity is desired. If step (ii) is performed and reacted in step (v), step (iii) is preferably also performed and reacted in step (v) in order to balance the sulfur and ammonia input into the absorber.

As will be understood by the skilled person, in order to preserve stoichiometry, if the SWSG is about equimolar in ammonia and hydrogen sulfide content and the production of ammonium sulfide in step (v) is desired, additional ammonia needs to be fed via step (iii). Generally, it is preferred to produce ammonium sulfide in step (v), in which case step (iii) is performed and process stream C is reacted in step (v) of the process.

In embodiment 2, the step (vi) preferably comprises reacting the aqueous solution of the ammonium (bi)sulfide of step (v) with sulfuric acid. The sulfuric acid can be provided as fresh (virgin grade) sulfuric acid and/or in the form of a waste stream from another process, such as spent alkylation sulfuric acid. Spent alkylation sulfuric acid is a composition which typically contains 50-95 wt. % sulfuric acid along with various contaminants from the related process, such as hydrocarbons. Typically, the amount of hydrocarbons in spent alkylation sulfuric acid is less than 15 wt. % (by weight of the sulfuric acid).

A specific implementation of embodiment 2 is illustrated in FIG. 2.

As can be seen in the process scheme of FIG. 2, in this implementation of embodiment 2, step (iii) is performed and process stream C is reacted in step (v) of the process. Furthermore, in this implementation of embodiment 2, the H₂S containing gases recovered from the ammonium sulfide column and/or the ammonium sulfate reactor can, in accordance with preferred implementations of embodiment 2, be fed to a Claus unit, and/or treated with a caustic scrubber before release into the atmosphere. The sulfur provided by the Claus unit and the SO₂ generated from incinerating off-gases of the Claus unit can be used in different processes.

In accordance with preferred implementations of embodiment 2, reaction step (v) is performed by continuously reacting process stream A provided in step (i), and optionally process streams B and C provided in step (ii) and (iii) with a continuously circulating aqueous medium comprising ammonium (bi)sulfide, wherein the aqueous solution of ammonium (bi)sulfide reacted in step (vi) is continuously recovered via a bleed stream from the continuously recirculating aqueous medium. In practice, the flow rate (in liter/hour) of liquid recirculated is typically at least 50, preferably at least 100 times the flow rate of the bleed stream, such that the ammonium (bi)sulfide gradient in the absorber is kept relatively small and the absorber can continuously operate under optimal conditions. The continuously recirculating aqueous medium preferably comprises 45-55 wt. % ammonium (bi)sulfide and 45-55 wt. % water.

### Embodiment 3: Production of Ammonium (Bi) Sulfide

In a particularly preferred embodiment of the invention, referred to herein as “embodiment 3”, there is provided a method for the production of ammonium (bi)sulfide and wherein step (v) comprises reacting process stream A with an aqueous medium to form an aqueous solution of ammonium (bi)sulfide. Embodiment 3 is preferably a method for the production of ammonium (bi)sulfide, comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) optionally providing a gaseous process stream B comprising more than 60 mol % (by total of the process stream B) hydrogen sulfide (H₂S);
(iv) optionally providing a process stream C comprising ammonia (NH₃);
(v) reacting process stream A provided in step (i), and optionally process streams B and C provided in steps (ii) and (iii) with an aqueous medium to form an aqueous solution of ammonium (bi)sulfide;
(vii) recovering the aqueous solution of ammonium (bi)sulfide of step (vi); and
(viii) optionally submitting the aqueous solution recovered in step (vii) to a treatment T2 to reduce the concentration of organic compounds in the aqueous solution;
   wherein
   the process stream A comprises sour water stripper gas (SWSG) obtained from stripping, preferably steam stripping, of sour water comprising organic compounds, wherein the sour water was submitted to a treatment T1 to reduce the concentration of organic compounds in the sour water before stripping.

In embodiment 3, step (iv) is generally not required since the process does not require SO₂. Step (ii) is optional and can be performed in case the SWSG has a low H₂S content or in case a more concentrated product or higher production capacity is desired. Similarly, step (iii) is optional and can be performed in case the SWSG has low ammonia content or in case a more concentrated product or higher production capacity is desired. Generally, it is preferred to perform step (ii) and step (iii) and react process streams B and C in step (v) of the process. As will be understood by the skilled person, in order to preserve stoichiometry, if the SWSG is about equimolar in ammonia and hydrogen sulfide content and the production of ammonium sulfide in step (v) is desired, additional ammonia needs to be fed via step (iii).

In embodiment 3, the step (vi) is not performed since the SWSG is used to make the end product (ammonium (bi)sulfide), and not to make an intermediate (as is the case in e.g. embodiment 2 and embodiment 4).

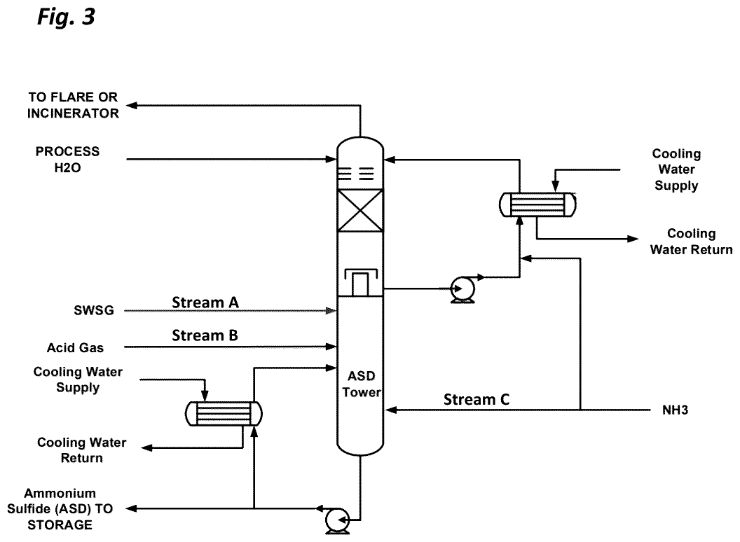

A specific implementation of embodiment 3 is illustrated in FIG. 3.

As can be seen in the process scheme of FIG. 3, in this implementation of embodiment 3, step (ii) and (iii) are performed and process streams B and C are reacted in step (v) of the process. Furthermore, in this implementation of embodiment 3, the H₂S containing gases recovered from the ammonium sulfide column can, in accordance with preferred implementations of embodiment 3, be fed to an incinerator to generate SO₂ which can be used in different processes, or can be fed to a Claus unit.

As can be seen in the process scheme of FIG. 3, in this implementation of embodiment 3, the absorber is a combination of a spray tower in the bottom part of the tower and a packed tower in the top part of the tower.

In accordance with preferred implementations of embodiment 3, reaction step (v) is performed by continuously process stream A provided in step (i), and optionally process streams B and C provided in steps (ii) and (iii) with a continuously circulating aqueous medium comprising ammonium (bi)sulfide, wherein step (vii) comprises obtaining a continuous bleed stream from the continuously recirculating aqueous medium. In practice, the flow rate (in liter/hour) of liquid recirculated is typically at least 50, preferably at least 100 times the flow rate of the bleed stream, such that the ammonium (bi)sulfide gradient in the absorber is kept relatively small and the absorber can continuously operate under optimal conditions. The continuously recirculating aqueous medium preferably comprises 45-55 wt. % ammonium (bi)sulfide and 45-55 wt. % water.

### Embodiment 4: Production of Ammonium Polysulfide

In a particularly preferred embodiment of the invention, referred to herein as “embodiment 4”, there is provided a method for the production of ammonium polysulfide wherein step (v) comprises reacting process stream A with an aqueous medium to form an aqueous solution of ammonium (bi)sulfide and step (vi) comprises reacting the ammonium (bi)sulfide obtained in step (v) with sulfur to obtain ammonium polysulfide. Embodiment 4 is preferably a method for the production of ammonium polysulfide, comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) optionally providing a gaseous process stream B comprising more than 60 mol % (by total of the process stream B) hydrogen sulfide (H₂S);
(iii) optionally providing a process stream C comprising ammonia (NH₃);
(v) reacting process streams A provided in step (i), and optionally process streams B and C provided in step (ii) and (iii) with an aqueous medium to form an aqueous solution of ammonium (bi)sulfide;
(vi) submitting the aqueous solution of ammonium (bi)sulfide to one or more further reaction steps to form an aqueous solution of ammonium polysulfide;
(vii) recovering the aqueous solution of ammonium polysulfide of step (vi); and
(viii) optionally submitting the aqueous solution recovered in step (vii) to a treatment T2 to reduce the concentration of organic compounds in the aqueous solution;
   wherein
   the process stream A comprises sour water stripper gas (SWSG) obtained from stripping, preferably steam stripping, of sour water comprising organic compounds, wherein the sour water was submitted to a treatment T1 to reduce the concentration of organic compounds in the sour water before stripping.

In embodiment 4, step (iv) is generally not required since the process does not require SO₂.

Step (ii) is optional and can be performed in case the SWSG has a low H₂S content or in case a more concentrated product or higher production capacity is desired.

Step (iii) is optional if ammonium bisulfide is being produced in step (v) and can be performed in case the SWSG has low ammonia content or in case a more concentrated product or higher production capacity is desired. If step (ii) is performed and reacted in step (v), step (iii) is preferably also performed and reacted in step (v) in order to balance the sulfur and ammonia input into the absorber.

As will be understood by the skilled person, in order to preserve stoichiometry, if the SWSG is about equimolar in ammonia and hydrogen sulfide content and the production of ammonium sulfide in step (v) is desired, additional ammonia needs to be fed via step (iii). Generally, it is preferred to produce ammonium sulfide in step (v), in which case step (iii) is performed and process stream C is reacted in step (v) of the process.

In embodiment 4, the step (vi) preferably comprises reacting the aqueous solution of the ammonium (bi)sulfide of step (v) with sulfur.

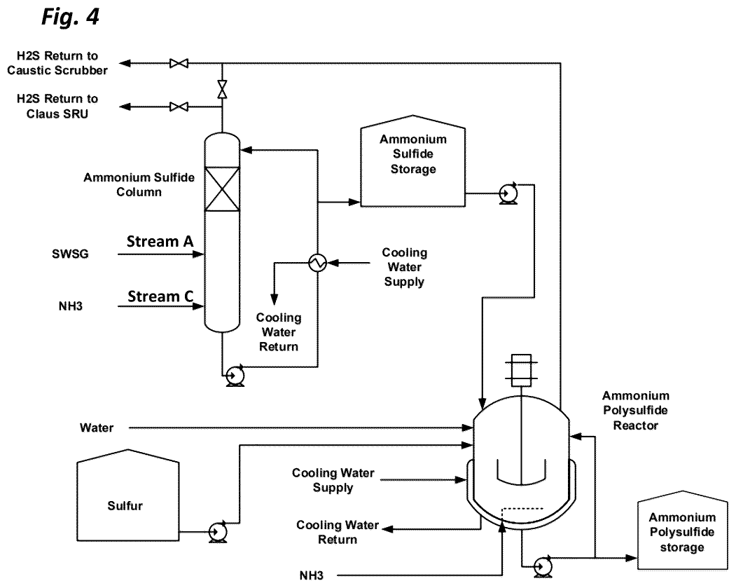

A specific implementation of embodiment 4 is illustrated in FIG. 4.

As can be seen in the process scheme of FIG. 4, in this implementation of embodiment 4, step (iii) is performed and process stream C is reacted in step (v) of the process. Furthermore, in this implementation of embodiment 4, the H₂S containing gases recovered from the ammonium sulfide column and/or the ammonium sulfate reactor can, in accordance with preferred implementations of embodiment 4, be fed to a Claus unit, and/or treated with a caustic scrubber before release into the atmosphere. The sulfur provided by the Claus unit and the SO₂ generated from incinerating off-gases of the Claus unit can be used in different processes.

In accordance with preferred implementations of embodiment 4, reaction step (v) is performed by continuously reacting process stream A provided in step (i), and optionally process streams B and C provided in step (ii) and (iii) with a continuously circulating aqueous medium comprising ammonium (bi)sulfide, wherein the aqueous solution of ammonium (bi)sulfide reacted in step (vi) is continuously recovered via a bleed stream from the continuously recirculating aqueous medium. In practice, the flow rate (in liter/hour) of liquid recirculated is typically at least 50, preferably at least 100 times the flow rate of the bleed stream, such that the ammonium (bi)sulfide gradient in the absorber is kept relatively small and the absorber can continuously operate under optimal conditions. The continuously recirculating aqueous medium preferably comprises 45-55 wt. % ammonium (bi)sulfide and 45-55 wt. % water.

In another aspect of the invention, there is provided a method for the production of an ammonium salt, comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) optionally providing a gaseous process stream B comprising more than 60 mol % (by total of the process stream B) hydrogen sulfide (H₂S);
(iii) optionally providing a process stream C comprising ammonia (NH₃);
(iv) optionally providing a gaseous process stream D comprising sulfur dioxide (SO₂);
(v) reacting process stream A provided in step (i) and optionally one or more of the process streams provided in steps (ii)-(iv) with an aqueous medium to form an aqueous solution of a first ammonium salt;
(vi) optionally submitting the aqueous solution of the first ammonium salt to one or more further reaction steps to form an aqueous solution of a second ammonium salt;
(vii) recovering the aqueous solution of the first ammonium salt of step (v) and/or the aqueous solution of the second ammonium salt of step (vi); and
(viii) optionally submitting one or both of the aqueous solutions recovered in step (vii) to a treatment T2 to reduce the concentration of organic compounds in the aqueous solution;
   wherein
   step (iii) is performed and step (v) comprises reacting streams A and C such that the ratio (mol:mol) of the total amount of ammonia (NH₃) provided by stream A to the total amount of ammonia (NH₃) provided by stream C is at least 1:20, preferably at least 1:10, most preferably at least 1:5. In preferred embodiments of this process, step (v) is implemented as a continuous process and step (v) comprises reacting streams A and C such that the ratio (mol:mol) of the total amount of ammonia (NH₃) provided by stream A per hour to the total amount of ammonia (NH₃) provided by stream C per hour is at least 1:20, preferably at least 1:10, most preferably at least 1:5. The process stream A preferably comprises sour water stripper gas (SWSG) obtained from stripping, preferably steam stripping, of sour water comprising organic compounds. Furthermore, the preferred embodiments of steps (i)-(viii) described herein earlier are equally applicable to this method.

In another aspect of the invention, there is provided a method for the production of an ammonium salt, comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) optionally providing a gaseous process stream B comprising more than 60 mol % (by total of the process stream B) hydrogen sulfide (H₂S);
(iii) optionally providing a process stream C comprising ammonia (NH₃);
(iv) optionally providing a gaseous process stream D comprising sulfur dioxide (SO₂);
(v) reacting process stream A provided in step (i) and optionally one or more of the process streams provided in steps (ii)-(iv) with an aqueous medium to form an aqueous solution of a first ammonium salt;
(vi) optionally submitting the aqueous solution of the first ammonium salt to one or more further reaction steps to form an aqueous solution of a second ammonium salt;
(vii) recovering the aqueous solution of the first ammonium salt of step (v) and/or the aqueous solution of the second ammonium salt of step (vi); and
(viii) optionally submitting one or both of the aqueous solutions recovered in step (vii) to a treatment T2 to reduce the concentration of organic compounds in the aqueous solution;
   wherein the total amount of acyclic C₁-C₉ saturated hydrocarbons comprised in process stream A is less than 0.2 mol % (by total of the process stream A), preferably less than 0.1 mol % (by total of the process stream A), most preferably less than 0.05 mol % (by total of the process stream A). In some embodiments the total amount of acyclic C₁-C₉ saturated hydrocarbons comprised in process stream A is even less than 0.01 mol % (by total of the process stream A) or 0.005 mol % (by total of the process stream A). The total amount of acyclic C₁-C₉ saturated hydrocarbons comprised in process stream A is preferably determined by GC/MS on a wet, as-is basis. Use of a drying or other conditioning agent will preferentially absorb some compounds in the stream resulting in incorrect analysis. The process stream A preferably comprises sour water stripper gas (SWSG) obtained from stripping, preferably steam stripping, of sour water comprising organic compounds. Furthermore, the preferred embodiments of steps (i)-(viii) described herein earlier are equally applicable to this method.

Since SWSG may have a varying hydrocarbon content depending on process conditions upstream of the sour water stripper, it is preferred that step (v) is implemented as a continuous process and the total amount of acyclic C₁-C₉ saturated hydrocarbons provided by process stream A over a 24 hour period, preferably over a 1 week period is less than 0.2 mol % (by total of the process stream A provided over the period), preferably less than 0.1 mol % (by total of the process stream A provided over the period), most preferably less than 0.05 mol % (by total of the process stream A provided over the period). In some embodiments step (v) is implemented as a continuous process and the total amount of acyclic C₁-C₉ saturated hydrocarbons provided by process stream A over a 24 hour period, preferably over a 1 week period is even less than 0.01 mol % (by total of the process stream A provided over the period) or 0.005 mol % (by total of the process stream A provided over the period).

For reference, the present inventors have tested two different sources of SWSG which were not submitted to a treatment T1. The samples are not conditioned and are sampled on a wet, as-is basis and analyzed by GC/MS. The results are shown in the below table.

| Results in mol % | SWSG 1 | SWSG2 |
|---|---|---|
| CH4: | 0.0305 | 0.0323 |
| C2H6: | 0.0450 | 0.0472 |
| C3H8: | 0.1041 | 0.0890 |
| iC4H10: | 0.0390 | 0.0546 |
| nC4H10: | 0.1759 | 0.2063 |
| iC5H12: | 0.0150 | 0.0442 |
| nC5H12: | 0.0479 | 0.0619 |
| C6H14: | 0.0659 | 0.1636 |
| C7H16: | 0.0311 | 0.0607 |
| C8H18: | 0.0181 | 0.0239 |
| C9H20: | 0.0028 | 0.0030 |
| Total C1-C9 saturated | 0.6232 | 0.8486 |
| acyclic hydrocarbon | | |

### EXAMPLES

A sour water stream having the following properties was provided:
Operating Temp.: 120° F.
Sour Water Sp. Gravity: 0.99
Sour Water Viscosity: 7 cP
Sour Water pH: 8.7
Hydrocarbon Phase Sp. Gravity: 0.63.

The sour water stream was fed at a rate of about 7.6 l/min to a 10 micron particulate filter to remove solids, and the filtrate was fed to a 20/40 micron liquid/liquid coalescing filter element to remove hydrocarbons.

The particle size distribution of the solid contaminants was determined at the inlet of the particulate filter and at the outlet of the coalescing filter and a significant reduction in contaminant size and volume concentration was observed.

The hydrocarbon content was analyzed at the inlet of the particulate filter and at the outlet of the coalescing filter by GC-MS and a significant reduction in each of C₆-C₁₂, C₁₃-C₂₈, and total hydrocarbons was observed.

1. A method for the production of an ammonium salt, comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) optionally providing a gaseous process stream B comprising more than 60 mol % (by total of the process stream B) hydrogen sulfide (H₂S);
(iii) optionally providing a process stream C comprising ammonia (NH₃);
(iv) optionally providing a gaseous process stream D comprising sulfur dioxide (SO₂);
(v) reacting process stream A provided in step (i) and optionally one or more of the process streams provided in steps (ii)-(iv) with an aqueous medium to form an aqueous solution of a first ammonium salt;
(vi) optionally submitting the aqueous solution of the first ammonium salt to one or more further reaction steps to form an aqueous solution of a second ammonium salt;
(vii) recovering the aqueous solution of the first ammonium salt of step (v) and/or the aqueous solution of the second ammonium salt of step (vi); and
(viii) optionally submitting one or both of the aqueous solutions recovered in step (vii) to a treatment T2 to reduce the concentration of organic compounds in the aqueous solution;
wherein
the process stream A comprises sour water stripper gas (SWSG) obtained from stripping, of sour water comprising organic compounds, wherein the sour water was submitted to a treatment T1 to reduce the concentration of organic compounds in the sour water before stripping.

2. The method according to claim 1, wherein step (i) of the method comprises the following steps:
(i)a providing sour water comprising organic compounds;
(i)b submitting the sour water to a treatment T1 to reduce the concentration of organic compounds in the sour water, thereby obtaining sour water with a reduced concentration of organic compounds; and
(i)c submitting the sour water obtained in step (i)b to stripping, to obtain the sour water stripper gas (SWSG) comprised in process stream A.

3. The method of claim 1, wherein the treatment T1 comprises treatment with a liquid-liquid coalescer to separate organic compounds from the sour water, thereby obtaining sour water with a reduced concentration of organic compounds.

4. The method according to claim 1, wherein the ratio TOC₀:TOC_{A} is more than 1.1:1, wherein TOC₀ is the total organic carbon content (TOC) of the sour water before the treatment T1, and wherein TOC_{A} is the total organic carbon content (TOC) of the sour water after the treatment T1.

5. The method according to claim 1, wherein the sour water before and after the treatment T1 comprises 0.05-5 wt. % (by total weight of the sour water) ammonia (NH₃), 0.05-5 wt. % (by total weight of the sour water) hydrogen sulfide (H₂S), and at least 90 wt. % water.

6. The method according to claim 1, wherein step (iv) is performed and wherein step (iv) comprises the following steps:
(iv)a providing a process stream E comprising more than 60 mol % (by total of the process stream E) hydrogen sulfide (H₂S);
(iv)b optionally reacting the process stream E in a Claus unit, wherein the H₂S comprised in the process stream E is at least partially converted to sulfur, thereby obtaining a process stream E′ comprising the off-gases of the Claus unit, the process stream E′ having a lower H₂S content than the process stream E; and
(iv)c incinerating the process stream E and/or the process stream E′ in an incinerator, wherein the H₂S comprised in process stream E and/or process stream E′ is at least partially converted to SO₂, thereby obtaining the process stream D.

7. The method of claim 6, wherein step (ii) is performed and wherein the process stream B and the process stream E originate from the same feed stream which is split into a portion forming the process stream B and into a portion forming the process stream E.

8. The method of claim 6, wherein a process stream F comprising more than 20 mol % (by total of the process stream F) of hydrogen sulfide (H₂S), more than 20 mol % (by total of the process stream F) of ammonia (NH₃) and more than 20 mol % (by total of the process stream F) of water vapor (H₂O) is provided, and wherein the process stream F is reacted in the Claus unit of step (iv)b together with the process stream E.

9. The method of claim 8, wherein the process stream A and the process stream F originate from different feed streams comprising sour water stripper gas (SWSG) having different total organic carbon (TOC) contents.

10. The method of claim 1, wherein step (iii) is performed and step (v) comprises reacting streams A and C such that the ratio (mol:mol) of the total amount of ammonia (NH₃) provided by stream A to the total amount of ammonia (NH₃) provided by stream C is at least 1:20.

11. The method of claim 1, wherein step (viii) is performed and wherein the treatment T2 comprises contacting the aqueous solution of the ammonium salt with a sorbent material, wherein the sorbent material comprises
(a) a macroporous hydrophobic nonfunctionalized resin having a BET surface area ranging from about 500 to about 1500 m²/g and a total porosity of greater than about 0.9 ml/g, or
(b) granular activated carbon and optionally glass fibers having a diameter ranging from about 0.001 to about 0.1 mm.

12. The method of claim 1, wherein the method is for the production of ammonium thiosulfate and wherein step (v) involves reacting process stream A with an aqueous medium comprising ammonium (bi)sulfite.

13. The method of claim 1, wherein the method is for the production of ammonium (bi)sulfate wherein step (v) comprises reacting process stream A with an aqueous medium to form an aqueous solution of ammonium (bi)sulfide and step (vi) comprises reacting the ammonium (bi)sulfide obtained in step (v) with sulfuric acid to obtain ammonium (bi)sulfate.

14. The method of claim 1, wherein the method is for the production of ammonium (bi)sulfide and wherein step (v) comprises reacting process stream A with an aqueous medium to form an aqueous solution of ammonium (bi)sulfide.

15. The method of claim 1, wherein the method is for the production of ammonium polysulfide wherein step (v) comprises reacting process stream A with an aqueous medium to form an aqueous solution of ammonium (bi)sulfide and step (vi) comprises reacting the ammonium (bi)sulfide obtained in step (v) with sulfur to obtain ammonium polysulfide.

16. A method for the production of an ammonium salt, comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) optionally providing a gaseous process stream B comprising more than 60 mol % (by total of the process stream B) hydrogen sulfide (H₂S);
(iii) optionally providing a process stream C comprising ammonia (NH₃);
(iv) optionally providing a gaseous process stream D comprising sulfur dioxide (SO₂);
(v) reacting process stream A provided in step (i) and optionally one or more of the process streams provided in steps (ii)-(iv) with an aqueous medium to form an aqueous solution of a first ammonium salt;
(vi) optionally submitting the aqueous solution of the first ammonium salt to one or more further reaction steps to form an aqueous solution of a second ammonium salt;
(vii) recovering the aqueous solution of the first ammonium salt of step (v) and/or the aqueous solution of the second ammonium salt of step (vi); and
(viii) optionally submitting one or both of the aqueous solutions recovered in step (vii) to a treatment T2 to reduce the concentration of organic compounds in the aqueous solution;
wherein
step (iii) is performed and step (v) comprises reacting streams A and C such that the ratio (mol:mol) of the total amount of ammonia (NH₃) provided by stream A to the total amount of ammonia (NH₃) provided by stream C is at least 1:20.

17. A method for the production of an ammonium salt, comprising the steps of:
(i) providing a gaseous process stream A comprising more than 20 mol % (by total of the process stream A) of hydrogen sulfide (H₂S), more than 20 mol % (by total of the process stream A) of ammonia (NH₃) and more than 20 mol % (by total of the process stream A) of water vapor (H₂O);
(ii) optionally providing a gaseous process stream B comprising more than 60 mol % (by total of the process stream B) hydrogen sulfide (H₂S);
(iii) optionally providing a process stream C comprising ammonia (NH₃);
(iv) optionally providing a gaseous process stream D comprising sulfur dioxide (SO₂);
(v) reacting process stream A provided in step (i) and optionally one or more of the process streams provided in steps (ii)-(iv) with an aqueous medium to form an aqueous solution of a first ammonium salt;
(vi) optionally submitting the aqueous solution of the first ammonium salt to one or more further reaction steps to form an aqueous solution of a second ammonium salt;
(vii) recovering the aqueous solution of the first ammonium salt of step (v) and/or the aqueous solution of the second ammonium salt of step (vi); and
(viii) optionally submitting one or both of the aqueous solutions recovered in step (vii) to a treatment T2 to reduce the concentration of organic compounds in the aqueous solution;
wherein the total amount of acyclic C₁-C₉ saturated hydrocarbons comprised in process stream A is less than 0.2 mol % (by total of the process stream A).
